(19) United States
(12) Patent Application Publication
(10) Pub. No.: US 2025/0250368 A1
(43) Pub. Date: Aug. 7, 2025

(54) PHOTOCURABLE COMPOSITIONS FOR THREE-DIMENSIONAL INVESTMENT PATTERN CASTING AND USE THEREOF

(71) Applicant: Henkel AG & Co. KGaA, Duesseldorf (DE)

(72) Inventor: STEFAN SALDIVER HINOTE, CONCORD, CA (US)

(21) Appl. No.: 19/092,333

(22) Filed: Mar. 27, 2025

Related U.S. Application Data
(63) Continuation of application No. PCT/US2023/033929, filed on Sep. 28, 2023.
(60) Provisional application No. 63/379,038, filed on Oct. 11, 2022.

(51) Int. Cl. C08F 2/50; B33Y 70/00; C08F 220/28

(52) U.S. Cl. CPC C08F 2/50; B33Y 70/00; C08F 220/281

(57) ABSTRACT

Thermally reversible, photocurable compositions is disclosed. The photocurable composition has high strength at low temperatures but also melts at elevated temperatures and is well suited as investment casting pattern composition.

### FIELD OF THE INVENTION

The present invention relates to photocurable compositions that polymerize to a solid when exposed to UV light and then softens and melts upon heating. The photocurable compositions are particularly useful for making three-dimensional investment patterns.

### BACKGROUND OF THE INVENTION

Investment casting is a process to make intricate objects in various industries by (1) creating a three-dimensional pattern, (2) making a shell on the three-dimensional pattern with a slurry composition, (3) removing the three-dimensional pattern from the shell with heat, (4) forming an object in the investment shell to be shaped where the pattern was removed, and (5) removing or destroying the shell from the object. Investment casting process allows for production of complex objects with excellent as-cast surface finishes with superior dimensional accuracy. Objects such as jewelry, turbine rotors, gears, electronic enclosures, valves, electronic components, medical devices, and the like, are cast from the pattern.

Two typical three-dimensional pattern creation for investment casting techniques are (1) fused deposition modeling (FDM) and (2) stereolithography (SLA)/digital light processing (DLP). Investment patterns produced by FDM materials melt at temperatures of 100-200° C., which allows for easier pattern removal; however, they lack accuracy and have low mechanical properties than SLA technology. Investment patterns produced by SLA and DLP resins offer superior accuracy and mechanical properties; however, their chemical compositions do not melt and must be burned at temperatures greater than 200° C. This high burn process can lead to thermal expansion of the investment pattern and can lead to cracks on the shell. Maintaining the integrity of the shell is important in the formation of the final object in investment casting process.

There is a need in the art for a highly accurate, high strength, and easily removable three-dimensional investment pattern. The current invention fulfills this need.

### BRIEF SUMMARY OF THE INVENTION

The invention provides thermally reversible, photocurable compositions for three-dimensional, investment casting patterns in the investment casting process. This three-dimensional pattern requires strong mechanical strength upon formation but softens and melts upon heating.

In one embodiment, the investment casting pattern composition comprises:
A) a monomer A having a glass transition temperature value less than about 25° C.;
B) a monomer B having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, irreversible chain transfer agent, antioxidant, hindered amine light stabilizer, or mixtures thereof.

In another embodiment, the invention is directed to a photocurable composition comprising:
A) a monomer A having a glass transition temperature value less than about 25° C.;
B) a monomer B having a glass transition temperature value greater than about 25° C.;
C) an oligomer having two or more furan maleimide Diels-Alder adducts;
D) a photoinitiator; and
E) an additive selected from the group consisting of a chain transfer agent, irreversible chain transfer agent, addition fragmentation chain transfer agent (AFCT), antioxidant, hindered amine light stabilizer, or mixtures thereof.

The photocurable composition may be used as an investment casting pattern that is the basis for forming objects in investment casting process. The photocurable composition can maintain high mechanical strength at temperatures below about 130° C., and softens and melts at temperatures above about 130° C. due to its thermally reversible bonds in the composition.

In yet another embodiment is directed to a method of making an investment casting shell comprising the steps of:
1) forming a three-dimensional pattern by
   a. preparing a photocurable composition comprising:
      A) a monomer A having a glass transition temperature value less than about 25° C.;
      B) a monomer B having a glass transition temperature value greater than about 25° C.;
      C) a thermally reversible crosslinker having a UV curable functionality and a thermally reversible covalent bond;
      D) a photoinitiator; and
      E) an additive selected from the group consisting of a chain transfer agent, irreversible chain transfer agent, antioxidant, hindered amine light stabilizer, or mixtures thereof; and
   b. photocuring the photocurable composition to form a hardened three-dimensional pattern having a first side and a second side, and wherein the second side is the outermost side;
2) applying a slurry solution onto the second side of the hardened three-dimensional pattern;
3) drying, curing or hardening the slurry solution to form a shell on the hardened pattern;
4) heating the hardened three-dimensional pattern and the shell to a temperature sufficient to soften the hardened three-dimensional pattern; and
5) separating the hardened three-dimensional pattern from the shell.

In another embodiment, the invention is directed to a method of making a removable photocurable composition comprising the steps of:
1) combining and mixing the following components to form a mixture:
   A) a monomer A having a glass transition temperature value less than about 25° C.;
   B) a monomer B having a glass transition temperature value greater than about 25° C.;
   C) a thermally reversible crosslinker having a UV curable functionality and a thermally reversible covalent bond;
   D) a photoinitiator; and
   E) an additive selected from the group consisting of a chain transfer agent, irreversible chain transfer agent, antioxidant, hindered amine light stabilizer, or mixtures thereof;
2) applying the mixture onto a substrate or depositing the mixture as a self-supporting 3D structure; and
3) photocuring the mixture to harden the removable photocurable composition. The removable photocurable composition can be removed by further
4) heating the removable photocurable at a temperature ranging from about 130 to about 250° C.

### BRIEF SUMMARY OF THE DRAWINGS

FIG. 1 is a schematic drawing of the cured photocurable composition.

FIGS. 2A-D are Differential Scanning calorimetry (DSC) curves of various compositions.

### DETAILED DESCRIPTION OF THE INVENTION

Investment casting is a process that surrounds a pattern with a slurry to make an investment shell. The shell is then separated from the pattern, typically with heat. Once separated, the investment shell is used as the basis to form objects, e.g., turbine rotors, gears, electronic enclosures, valves, electronic components, medical devices, and the like.

The three-dimensional objects are photocurable with actinic radiation, which are electromagnetic radiation that can produce photochemical reactions.

The term melting point of a substance herein refers to the temperature at which it changes state from solid to liquid. At the melting point the solid and liquid phase exist in equilibrium. The term softening point herein refers to the temperature at which a substance softens, particularly the temperature at which an amorphous material starts to soften.

A monomer herein is defined as molecule that can polymerizable into a polymer. The monomer may be monofunctional having a single functional polymerizable group or a multifunctional monomer which has more than on functional polymerizable group. The molecular weight of the monomer be a low molecular weight (e.g., about 100 to about 1,000 Daltons), medium molecular weight (e.g., about 1000 to about 5,000 Daltons) or high molecular weight (about 5,000 to about 20,000 Daltons).

The invention provides thermally reversible, photocurable compositions for investment pattern. The pattern must be formed so that it maintains the integrity of both itself and the shell is during heating and the removal process. In one embodiment, the investment casting pattern composition comprises:
A) a monomer A having a glass transition temperature value less than about 25° C.;
B) a monomer B having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, reversible chain transfer agent (RAFT), antioxidant, hindered amine light stabilizer, or mixtures thereof.

The investment casting pattern composition requires a combination of cationically curable or radically curable monomers to form a polymeric backbone. A combination of a monomer A having a glass transition temperature value less than about 25° C. and a monomer B having a glass transition temperature value greater than about 25° C. provides a polymeric network suitable for investment pattern.

The backbone is formed with at least two monomers, each monomer independently having functional groups selected from (meth)acrylates, acrylates, vinyl esters, vinyl, ethers, allyl, N-vinyls, vinylamides, thiols, (meth)acrylamides, vinyl carbonates, acryloyls, vinyl carbamates, maleimides, cyanoacrylates, thiols and epoxides, styrenics, vinyl halides, acrylonitriles, nadimides, itaconimides, and vinyl ether. The term “backbone” is intended to refer to a chemical moiety to which or between which the functional group(s) are attached. In another embodiment, the backbone is formed with a single monomer.

The monomer A has a glass transition (Tg) temperature value less than about 25° C., preferably less than about 0° C., and most preferably less than about −15° C., and contains at least one reactive group listed above. The functional group of monomer A is particularly preferred to be an methacrylate or acrylate. Particularly preferred examples of monomer A includes lauryl acrylate (Tg=15° C.), lauryl methacrylate (Tg=−65° C.), isodecyl acrylate (Tg=−58° C.), isodecyl methacrylate (Tg=−70° C.), 2-propylheptyl acrylate (Tg=−68° C.), isobutyl acrylate (Tg=−24° C.), ethyldiglycol acrylate (Tg=−53° C.), heptadecyl acrylate (Tg=−64° C.), and 4-hydroxybutyl acrylate (Tg=−65° C.).

Monomer A is present in ranges from about 1 to about 30 wt %, preferably about 3 to about 15 wt %, of the total investment casting pattern composition investment casting pattern composition.

The monomer B has a glass transition temperature value greater than about 25° C., preferably greater than 50° C., more preferably greater than 75° C. The monomer B is particularly preferred to contain methacrylate, acrylate, vinyl ester, vinyl, ether, allyl, N-vinyl, vinylamide, acrylamide, vinyl carbonate, acryloyl, vinyl carbamate, maleimide, cyanoacrylate, thiol or epoxide functional group.

Examples of the reactive group in monomer B group include isobornyl acrylate (Tg=95° C.), isobornyl methacrylate (Tg=110° C.), n-vinyl caprolactam (Tg=125° C.), cyclohexyl methacrylate (Tg=92° C.), hydroxyethyl methacrylate (Tg=55° C.), hydroxypropyl methacrylate (Th=76° C.), phenyl methacrylate (Tg=110° C.), methacrylic acid (Tg=228° C.), acrylamide (Tg=165° C.), n-vinyl pyrrolidone (Tg=150° C.), acryloyl morpholine (Tg=145° C.), and n,n-dimethyl acrylamide (Tg=119° C.).

Monomer B is present in ranges from about 10 to about 75 wt %, preferably about 20 to about 60 wt %, more preferably about 25 to about 55 wt % of the total investment casting pattern composition.

The combination of the two monomers having varied Tg allows for a balanced property of high strength and ductility and modulus. If the monomer combination in the investment casting exhibited too high Tg, e.g., greater than 100° C., then the resultant polymers will exhibit high viscosity when heated, which will have difficulty with softening. In contrast, if the monofunctional monomer used have too low of Tg, e.g., below 20C then the resultant polymer will exhibit poor mechanical properties and the investment pattern will deform under any applied stress.

The combined monomers, in the above ranges, with thermally reversible crosslinker provides sufficient mechanical and physical properties in softness and tensile strength and formability while retaining the capability to melt.

Modulus of the backbone, monomer A and monomer B, with the thermally reversible crosslinker should be greater than about 10 MPa of Young's modulus, in accordance with ASTM D638.

The investment casting pattern composition further comprises a thermally reversible crosslinker. The thermally reversible crosslinkers have a UV curable functionality and a thermally reversible covalent bond. The thermally reversible crosslinker is prepared by reacting:
a) bismaleimide or a compound having to two or more maleimide group
with
b) furfuryl methacrylate or furfuryl arylate
   Where the molar ratio of a to b is 1:0.5 to 1:2.

In one embodiment, the thermally reversible crosslinker is prepared by reacting a bismaleimide with two molar equivalents of furfuryl methacrylate. In another, the thermally reversible crosslinker is prepared by reacting a bismaleimide with two molar equivalents of furfuryl acrylate. In yet another embodiment, the thermally reversible crosslinker is prepared by reacting a starting material containing two or more maleimide groups with half molar to one molar equivalent of furfuryl methacrylate per maleimide. In another embodiment, the thermally reversible crosslinker is prepared by reacting a starting material containing two or more maleimide groups with half molar to one molar equivalent of furfuryl acrylate per maleimide. In another embodiment, the thermally reversible crosslinker is prepared by reacting a bismaleimide with two molar equivalents of reactant containing one furfuryl and one methacrylate group. In yet another embodiment, the thermally reversible crosslinker is prepared by reacting a bismaleimide with two molar equivalents of reactant containing one furfuryl and one acrylate group.

The Diels-Alder reaction forms an adduct of bismaleimide and furfuryl acrylate at temperature up to about 80° C.; and the adduct is thermally reversible through retro Diels-Alder reaction, at about 80 to about 180° C. The adduct can be formed as the temperature is ramped up to about 80° C., and once the adduct reaches the reversal temperature from about 80 to 180° C., the bond dissociates. For best way to dissociate the adduct, the adduct is held at above the reversal temperature for a minimum time. The temperature and time can be determined by with experimentation by those skilled in the art, e.g., higher temperature for shorter length time or lower temperature for longer length of time.

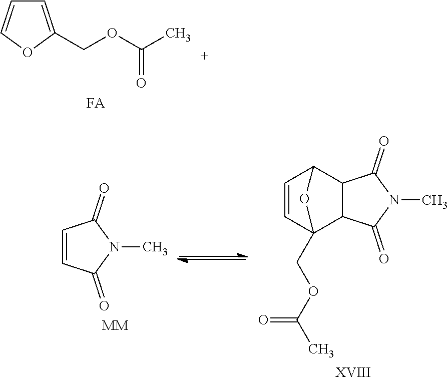

The thermally reversible crosslinker forms a network reaction of polymers with pendant furan and/or maleimide heterocycles.

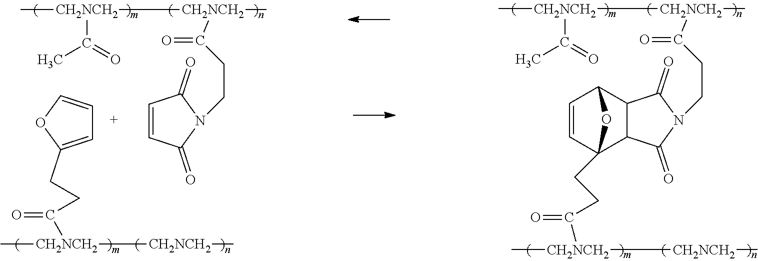

The stereochemistry and actual position of the furan or bismaleimide within the polymer chain determines its reactivity.

In one example, the thermally reversible crosslinker is furan-maleimide Diels-Alder adduct of bismaleimide (1,1′-(Methylenedi-4,1-phenylene)bismaleimide, reacted with two molar equivalents of furfuryl methacrylate to form (methylenebis(4,1-phenylene))bis(1,3-dioxo-2,3,3a,4, 7, 7a-hexahydro-1H-4, 7-epoxyisoindole-2,5-diyl) bis(2-methylacrylate).

In yet another embodiment, the thermally reversible crosslinker is prepared by reacting a polyimide bearing pendant maleimide functions and a trifuran derivative.

In one embodiment, the thermally reversible crosslinker is prepared by reacting a bismaleimide with two molar equivalents of furfuryl glycidyl ether. In another embodiment, the thermally reversible crosslinker is prepared by reacting a starting material containing two or more maleimide groups with half molar to one molar equivalent of furfuryl glycidyl ether per maleimide.

In another embodiment, the thermally reversible crosslinker is prepared by reacting a bismaleimide with two molar equivalents of reactant containing one furfuryl and one epoxy group.

In another embodiment, the thermally reversible crosslinker is prepared by reacting a bismaleimide with two molar equivalents of reactant containing one furfuryl and one acrylamide group.

In another embodiment, the thermally reversible crosslinker is prepared by reacting a bismaleimide with two molar equivalents of reactant containing one furfuryl and one methacrylamide group.

In another embodiment, the thermally reversible crosslinker is prepared by reacting a bismaleimide with two molar equivalents of reactant containing one furfuryl and one vinyl group.

In another embodiment, the thermally reversible crosslinker is prepared by reacting a bismaleimide with two molar equivalents of reactant containing one furfuryl and one vinyl group.

In another embodiment, the thermally reversible crosslinker is prepared by reacting a bismaleimide with two molar equivalents of reactant containing one furfuryl and one vinyl ester group.

In another embodiment, the thermally reversible crosslinker is prepared by reacting a bismaleimide with two molar equivalents of reactant containing one furfuryl and one vinyl ether group.

In another embodiment, the thermally reversible crosslinker is prepared by reacting a bismaleimide with two molar equivalents of reactant containing one furfuryl and one cyanoacrylate group.

The thermally reversible crosslinker can have varied molecular ranges from low (about 500 to about 1,000 Daltons), medium (about 1,000 to about 5,000) and high (5,000 to about 10,000 Daltons). Depending on factors such as the viscosity, kinetics, miscibility, and the like, a skilled artisan can pick the proper thermally reversible crosslinker with proper molecular weight range.

The thermally reversible crosslinker is present in about 10 to about 90 wt %, preferably about 20 to about 50 wt %, of the total investment casting pattern composition.

The investment casting pattern composition also comprise a photoinitiator, including both Type I and Type II photoinitiators. Appropriate photoinitiators include triazines, ketones, peroxides, diketones, azides, azo derivatives, disulfide derivatives, disilane derivatives, thiol derivatives, diselenide derivatives, diphenylditelluride derivatives, digermane derivatives, distannane derivatives, carbo-germanium compounds, carbon-silicon derivatives, sulfur-carbon derivatives, sulfur-silicon derivatives, peresters, Barton's ester derivatives, hydroxamic and thiohydroxamic acids and esters, organoborates, organometallic compounds, titanocenes, chromium complexes, aluminate complexes, carbon-sulfur or sulfur-sulfur iniferter compounds, oxyamines, aldehydes, acetals, silanes, phosphorous-containing compounds, borane complexes, thioxanthone derivatives, coumarins, anthraquinones, fluorenones, and ferrocenium salts. Particularly desirable photoinitiators include benzophenone, anthraquinone, and fluoroenone. In one embodiment, the photoinitiator is a Norish type I initiators selected from 2,4,6-trimethylbenzoyl-diphenyl phosphine oxide (TPO), 1-Hydroxycyclohexyl-phenyl ketone, bis(2,4,6-trimethylbenzoyl)-phenylphosphineoxide (BAPO) or ethyl (2,4,6-trimethylbenzoyl)phenylphosphinate (TPO-L) and are available from IGM Resins under the tradename OMNIPOL TP series.

Commercially available photoinitiators include OMIRAD TPO (2,4,6-trimethylbenzoyl-diphenyl phosphine oxide), OMIRAD 184 (1-Hydroxycyclohexyl-phenyl ketone), IRGACURE series, CHEMCURE series, DAIDO UV cure series, and the like.

When used, the photoinitiator are present in an amount of from about 0.01 to about 15 wt % of the total composition.

The investment casting pattern composition may contain but does not require a thermal initiator.

The investment casting pattern composition may further comprise additives, including chain transfer agent, irreversible chain transfer agent, antioxidant, hindered amine light stabilizer, amine synergist (both reactive and non-reactive), optical brighteners, UV blockers, filers including both inorganic and organic fillers, dyes and pigments, waxes and wax-like additives, plasticizers or mixtures thereof.

Chain transfer agents include free radical living polymerization catalyst, catalytic chain transfer agent, reversible addition fragmentation chain transfer (RAFT) agent, and iodine transfer agent for polymerization.

Particularly preferred additive is addition fragmentation chain transfer agent. Exemplary agents include allyl sulfide, allyl phenyl sulfone, ethyl 2-tosyloxyacrylate, ethyl 2-(1-hydroxyperoxyethyl) propenoate, mono-beta-allyl sulfone, alpha-(benzyloxy) styrene, carbon tetrachloride, carbon tetrabromide, bromotrichloromethane, 4-methylbenzenethiol, pentaphenylethane, tert-nonyl mercaptan, 4,4′-thiobisbenzenethiol, n-octyl mercaptan, thioglycolic acid, and mixtures thereof. The is addition fragmentation chain transfer agent can design and aid in the reversibility of the investment cast.

The Diels-Alder reaction of bismaleimide and furfuryl acrylate, under free radical polymerization, undergoes side reactions that form branches on the polymer backbones. This builds up the molecular weight and impacts irreversible crosslinking reaction in investment casting. To circumvents the branching side reactions in polymer and effectively reduce the molecular weight. The chain transfer agent is added to the investment casting composition. Adding this chain transfer reagent allows the polymer to soften at around 130° C. of the investment casting composition. This allows the investment casting composition to soften sufficiently to dissociate from the master pattern with heat.

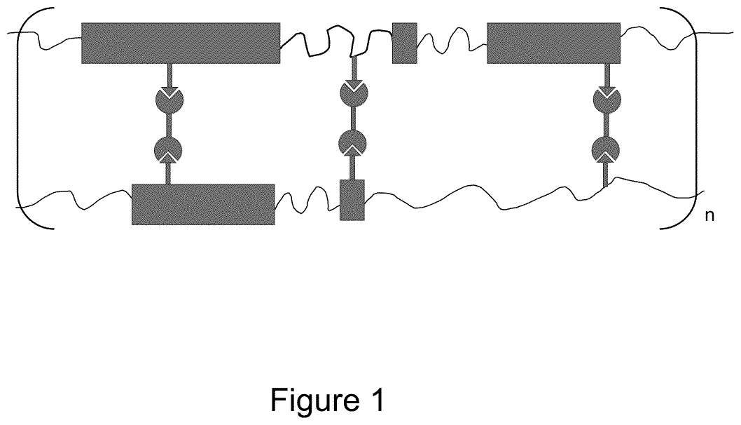

FIG. 1 is a schematic drawing of the cured photocurable composition. The boxes represent the hard segments formed from high Tg monomers. Hard segments provide rigidity and strength to the cured article. The soft segments formed from the low Tg monomers are represented by lines, these provide flexibility and toughness to the cured article. The thermally reversible crosslinkers are represented as balls that are connected to the hard segments and they can unlink and dissociate under heat. The chain transfer agents can tune the molecular weight of the polymer and decrease the unit length (n) of the polymer. Under sufficient thermal exposure the cured photocurable composition softens and melts due to dissociation of thermally reversible crosslinkers and glass transition temperature reached.

Exemplary antioxidants include butylated hydroxytoluene, 4-methoxyphenol, 4,4′-Thiobis(2-tert-butyl-5-methylphenol), 2,2′-methylenebis(6-tert-butyl-4-methylphenol), 2,5-Di(tert-amyl) hydroquinone, bis(2,4-di-tert-butylphenyl) pentaerythritol diphosphate, and tris(2, 4-di-tert-butylphenyl)phosphite.

Exemplary hindered amine light stabilizers include N,N′,N″,N″-tetrakis(4,6-bis(butyl-(N-methyl-2,2,6,6-tetramethylpiperidin-4-yl) amino)triazin-2-yl)-4,7-diazadecane-1,10-diamine, Bis(1-octyloxy-2,2,6,6-tetramethyl-4-piperidyl) sebacate, decanedioic acid, 1,10-bis(1,2,2,6,6-pentamethyl-4-piperidinyl) ester decanedioic acid, 1-methyl 10-(1,2,2,6,6-pentamethyl-4-piperidinyl), and bis(2,2,6,6-tetramethyl-4-piperidyl) sebacate.

Typical amine synergists or co-initiators commonly used with type Il photoinitiators include, but are not limited to, tertiary aliphatic amines such as methyldiethanolamine, dimethylethanolamine, triethanolamine, triethylamine and N-methylmorpholine; aromatic amines such as amylparadimethylaminobenzoate, 2-n-butoxyethyl-4-(dimethylamino)benzoate, 2-(dimethylamino)ethylbenzoate, ethyl-4-(dimethylamino)benzoate, and 2-ethylhexyl-4-(dimethylamino)benzoate; and (meth)acrylated amines such as dialkylamino alkyl (meth)acrylates (e.g., diethylaminoethylacrylate) or N-morpholinoalkyl-(meth)acrylates (e.g., N-morpholinoethyl-acrylate).

In certain embodiments, the photocurable compositions may comprise one or more optical brighteners (i.e. optical brightening agents). Optical brighteners, optical brightening agents (OBAs), fluorescent brightening agents (FBAs), or fluorescent whitening agents (FWAs), are chemical compounds that absorb light in the ultraviolet and violet region (usually 340-370 nm) of the electromagnetic spectrum, and re-emit light in the blue region (typically 420-470 nm) by fluorescence. Suitable optical brighteners include but are not limited to: bis-benzoxazoles; coumarins; stilbenes, including triazine-stilbene, and biphenyl stilbenes; diazoles; triazoles; benzoxazolines; combinations thereof; and the like. Fluorescent brighteners are preferred. In some embodiments, optical brighteners act as a sensitizer. Commercially available optical brighteners include, but are not limited to, Optiblanc PL (3 V Sigma); Benetex OB, OB Plus, and OB-M1 (Mayzo).

UV blockers Any suitable filler may be used in connection with the various embodiments described herein, depending on the properties desired in the part or object to be made. Thus, fillers may be solid or liquid, organic or inorganic, and may be reactive and non-reactive rubbers, examples of all of which include siloxanes, organic phosphinates, acrylonitrile-butadiene rubbers; reactive and non-reactive thermoplastics (such as poly(ether imides), maleimide-styrene terpolymers, polyarylates, polysulfones and polyethersulfones) inorganic fillers such as silicates (such as talc, clays, silica, or mica), glass, carbon nanotubes, graphene, carbon-fiber, metals and cellulose nanocrystals and combinations thereof.

Any suitable filler may be used in connection with the various embodiments described herein, depending on the properties desired in the part or object to be made. Thus, fillers may be solid or liquid, organic or inorganic, and may be reactive and non-reactive rubbers, examples of all of which include siloxanes, organic phosphinates, acrylonitrile-butadiene rubbers; reactive and non-reactive thermoplastics (such as poly(ether imides), maleimide-styrene terpolymers, polyarylates, polysulfones and polyethersulfones) inorganic fillers such as silicates (such as talc, clays, silica, or mica), glass, carbon nanotubes, graphene, carbon-fiber, metals and cellulose nanocrystals and combinations thereof. One or more polymeric and/or inorganic tougheners may be included in the photocurable composition. The toughener may be substantially uniformly distributed in the form of particles in the polymerized product. The particles can be less than 5 μm in diameter. Such tougheners include those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, and fullerenes), ceramics and silicon carbides, with or without surface modification or functionalization. Core-shell particles whose compositions are described in U.S. Patent Application Publication Nos. 2010/0280151 and 2007/0027233, the entire contents of which are incorporated herein by reference, may also be added as fillers. In some embodiments, the core-shell rubber particles are nanoparticles i.e., having an average particle size of less than 1000 nanometers (nm)]. Generally, the average particle size of the core-shell rubber nanoparticles is less than 500 nm, e.q. less than 300 nm, less than 200 nm, less than 100 nm, or even less than 50 nm. Typically, such particles are spherical, so the particle size is the diameter; however, if the particles are not spherical, the particle size is defined as the longest dimension of the particle.

Exemplarily wax and wax-like additive include microcrystalline wax, beeswax, carnauba wax, paraffin wax, polyethylene glycol wax, candelilla wax, ozokerite wax, oricurry wax, microcrystalline wax, amide wax, erucamide wax, polypropylene wax, paraffin wax, polyethylene wax, polytetrafluoroethylene wax, carnauba wax, polyethylene glycols, having a molecular weights greater than 1000 Daltons, poly(tetramethylene ether) glycols having a molecular weights over 650 Daltons, and the like. The wax may be a combination of said waxes. The wax and wax-like additive may also have a reactive or non-reactive functionality on the wax and wax-like additive.

In certain embodiments, the photocurable compositions may comprise one or more plasticizers, suitable plasticizers include, but not limited to: phthalic acid esters, esters based on benzoic acid, polyketones, esters of diphenic acid, ester of cyclohexane polycarboxylic acid, dialkyl adipate, or a mixture thereof. Some examples include: bis(2-ethylhexyl phthalate) (DEHP or DOP), diisononyl phthalate (DINP), dioctyl phthalate (DnOP), diisodecyl phthalate (DIDP), dipropylheptyl phthalate (DPHP), di-2-ethylhexyl terephthalate (DOTP or DEHT), and diisononyl-1,2 cyclohexane dicarboxylate (DIDC, an example of which is BASF's Hexamoll®) DINCH®).

The photocurable composition can have additional ingredients solubilized or dispersed therein, including pigments, dyes, detectable compounds (e.g., fluorescent, phosphorescent, and radioactive), fillers, light absorbers, dispersing agents, slip agents, leveling agents, optical brighteners, antifoaming agents, antistatic agents, UV sensitizers, waxes, plasticizers, amine synergists or co-initiators, or inhibitors of polymerization, again depending upon the particular purpose of the product being fabricated.

In certain embodiments, the photocurable compositions may comprise one or more surfactants or dispersing agents. Surfactants include but not limited to an anionic surfactant, a nonionic surfactant, a cationic surfactant, or an amphoteric surfactant. Examples of the anionic surfactant encompass fatty acid sodiums such as mixed fatty acid sodium soap and sodium stearate, higher alcohol sodium sulfate, sodium alkyl sulfate, alkyl benzene sulfonate, and the like. Examples of the cationic surfactant and the amphoteric surfactant encompass alkylamines, alkylbetaine, and the like. Examples of the dispersing agent encompass ethyl cellulose, ethyl hydroxyethyl cellulose, and the like.

In certain embodiments, the photocurable compositions may comprise one or more slip agents. Slip agents include but are not limited to: silicones, such as polydimethylsiloxane (PDMS), fluoropolymers, alkyl ketal esters, and fatty acid amides. Generally fatty acid amides are derived from aliphatic saturated and/or unsaturated fatty acids containing between 16 and 22 carbon atoms, including but not limited to: erucamide, oleamide, stearamide, behenamide, oleyl palmitamide.

In certain embodiments, the photocurable compositions may comprise one or more leveling agents. Leveling agents include but are not limited to polyaminoamide and derivatives thereof, polyalkanolamine and derivatives thereof, polyethylene imine and derivatives thereof, quaternized polyethylene imine, polyglycine, poly(allylamine), polyaniline, polyurea, polyacrylamide, poly(melamine-co-formaldehyde), reaction products of amines with epichlorohydrin, reaction products of an amine, epichlorohydrin, and polyalkylene oxide, reaction products of an amine with a polyepoxide, polyvinylpyridine, polyvinylimidazole, polyvinylpyrrolidone, or copolymers thereof, nigrosines, pentamethyl-para-rosaniline hydrohalide, hexamethyl-pararosaniline hydrohalide, or compounds containing a functional group of the formula N—R—S, where R is a substituted alkyl, unsubstituted alkyl, substituted aryl or unsubstituted aryl. Typically, the alkyl groups are (C1-C6)alkyl and preferably (C1-C4)alkyl. In general, the aryl groups include (C6-C20) aryl, preferably (C6-C10) aryl. Such aryl groups may further include heteroatoms, such as sulfur, nitrogen and oxygen. It is preferred that the aryl group is phenyl or napthyl. The compounds containing a functional group of the formula N—R—S are generally known, are generally commercially available and may be used without further purification.

The additives are present in an amount of from about 0.01 to about 60 wt %, preferably from about 1-25 wt %, and more preferably from about 1 to about 10 wt % of the total composition.

The composition is then prepared by combining the components together, mixing until they are reacted. The reacted mixture applied onto a substrate or deposited as a self-supporting 3D structure either by coating, lithography and/or printing. The application includes digital light processing, stereolithography, slot die coating, spray coating, wet-coating, screen-printing UV-nano-imprint lithography or photo-nano imprint lithography, step and flash imprint lithography, selective laser sintering, fused deposition modeling, fused filament fabrication, polyjet, inkjet printing, and the like. A skilled artisan may modify the viscosity of the composition to suit the chosen application method with solvent, monomers, and rheology modifiers.

For photocuring the photocurable composition, the composition is exposed to radiation in the electromagnetic spectrum in a range of 355 nm to 405 nm. The radiation may be emitted from a LED source, which may be chosen from a laser, a plurality of lasers, a projector or a plurality of projectors. The LED source may be applied from beneath or from above a reservoir in which is contained the photocurable composition.

Curing is conducted by exposing the composition to an actinic radiation, UV light and visible light, which causes the composition to polymerize and harden. Single reaction mechanism energy polymerization involves the use of energy to initiate and drive the polymerization through one reaction mechanism. Irradiation through exposure to actinic radiation, UV light and Visible light. Such examples include UV light (100 nm-405 nm), Visible Light (405 nm-700 nm) or Electron beam. Examples of suitable light sources include LEDs, laser diodes, laser beams, lamps (halogen lamp, Xe, Xe—Hg lamps, etc.), LED Lasers or LED projectors used in additive manufacturing, Visible light irradiating LCD, LED or Plasma screens, mobile or tablet devices. This polymerization then is carried out through a single reaction mechanism, such as free radical, cationic, Michael addition, step-growth, click-chemistry, to name a few. The photocurable composition, which is typically in a liquid or in a viscous state, polymerizes and form a three-dimensional solid.

Optionally, the formed investment cast pattern may be treated with a solvent or a wash liquid. The solvent or wash liquid may be chosen from lower alkyl alcohols, such as isopropanol, or mild surfactants. The solvent or wash liquid may be heated to an elevated temperature in use here. In this manner, un-reacted material on the surface of the part may be rendered flowable, so as to more easily remove the un-reacted material via solvation or mechanical agitation, such as sonication.

The investment pattern has dimensional stability defined as 90% of the final part structure within a certain tolerance or error when compared to the original design/CAD model such as less than about 500 μm, such as 200 μm, desirably 100 μm dimensional inaccuracy.

On the investment pattern, a slurry is formed and introduced onto the outer layer of the pattern and then hardened as a shell. This can be either dried or cured. The hardened investment shell is then heated to a temperature sufficient to soften the investment pattern and removed from the investment shell. Above a specific temperature, particularly in the range of about 120 to about 200° C., more preferably in the range of about 130 to about 180° C., the investment pattern softens, and can be readily removed from the shell. The investment pattern composition can be designed by fine tuning the thermally reversible crosslinker and chain transfer agent to soften at a specific temperature within 120 to 200° C. range. In one embodiment, the photocurable composition provides high mechanical strength below 130° C. and melting at temperatures above 130° C.

Without being bound to any specific theory, the addition of difunctional monomer or oligomer with the balanced Tg imparts strength to the polymer backbone. This is akin to difunctional monomer/oligomer's irreversible crosslinking system, akin to thermoset, which does not melt under heating, but rather burns. The investment casting composition herein is designed to de-crosslink the difunctional monomer/oligomers upon heat exposure via reversible Diels-Alder reaction. The combination of the reversible Diels-Alder and chain transfer reagent that reduces side chain and decrease the overall molecular weight of the polymer allows the investment casting pattern to soften at around 130° C. The investment casting composition described herein is designed to produce mechanical strength below at above 130° C. while being ductile at above about 130° C. This unique set of characteristics find uses in pharmaceutical, agricultural, adhesive, and packaging industries.

The heat allows thermal reversibility of the photocurable composition. This has many uses, including investment casting process and beyond. Three-dimensional printing can use used to apply the thermally reversible photocurable composition, where rework or removability is required. This composition may be applied in various ways

The separated investment shell can then be used as the basis to form an object or a widget. A second composition is formed on the innermost layer of the investment shell and then hardened, essentially taking the shape of the removed pattern. After curing the second composition, the investment shell can be removed either by heat or destroying it to separate from the object.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

### EXAMPLES

Thermally reversible crosslinker was made by dissolving 1,1′-(methylenedi-4,1-phenylene)bismaleimide in acryloyl morpholine (ACMO) by centrifugal mixing, 2000 RPM for five minutes with two equivalents of furfuryl methacrylate. This solution was transferred to a round bottom flask and mixed at 100 RPM for eight hours at 60° C., and then cooled to 25° C. for 24 hours.

Samples A-D were each made by combining all components listed in Table 1 into a vessel, and then mixing with an overhead mixer (cowles blade) at 800 RPM for two hours. The formed liquid resin was then loaded into a DLP based 3D printer, configured to print at 100 micron layers, 75 mJ/cm\hat{ }2 dose per layer, and printed ASTM D638 Type IV specimens. This was post-processed by rinsing the specimens in isopropanol alcohol for two minutes, and then letting it air dry at 25° C. for 30 minutes. Each specimen was post-cured with a mercury bulb for 1500 mJ/cm\hat{ }2 (total exposure energy) and then stored at 25° C. for 24 hours before testing with an Instron dual beam equipment.

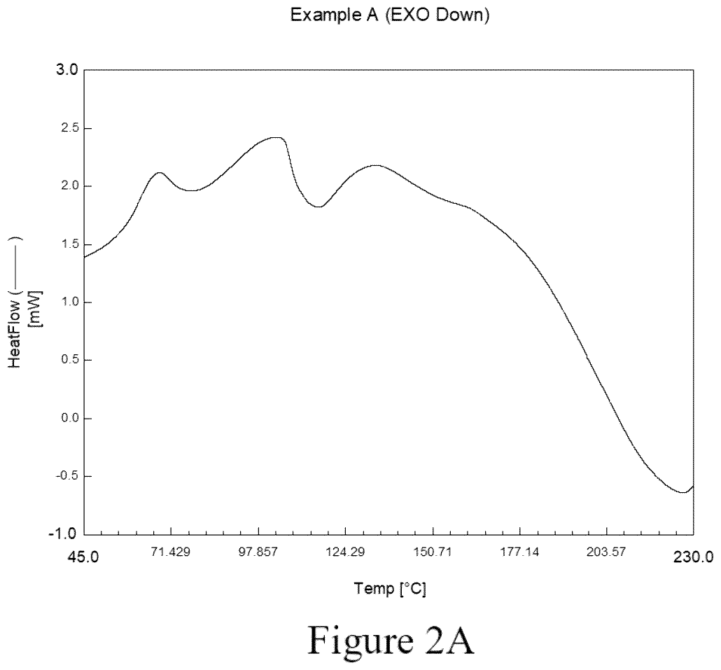

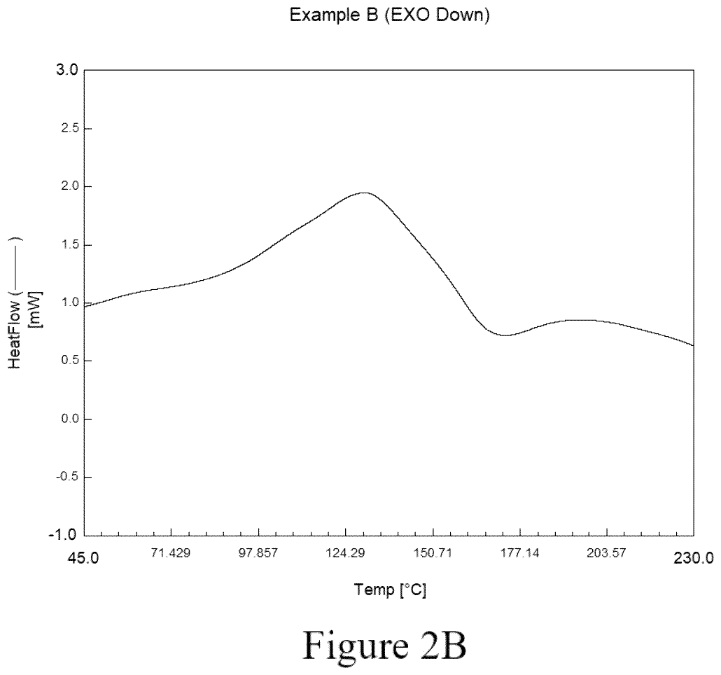

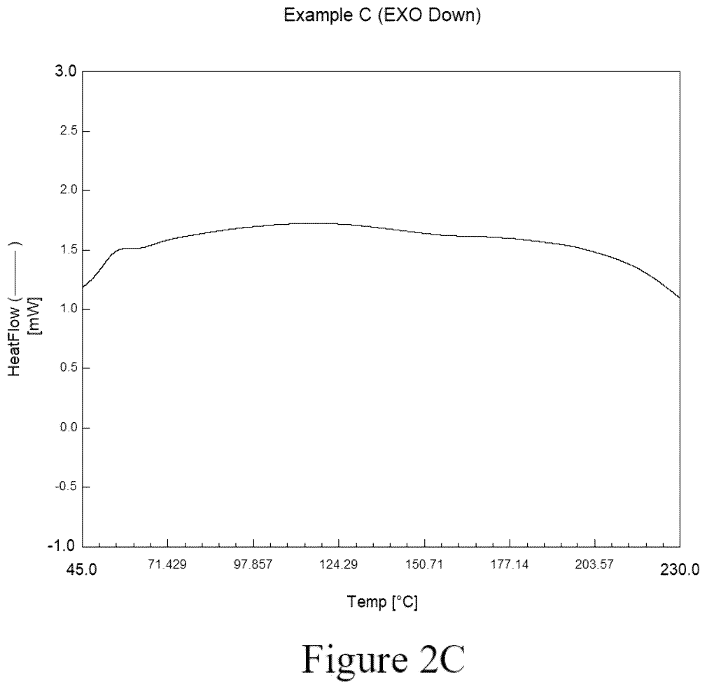

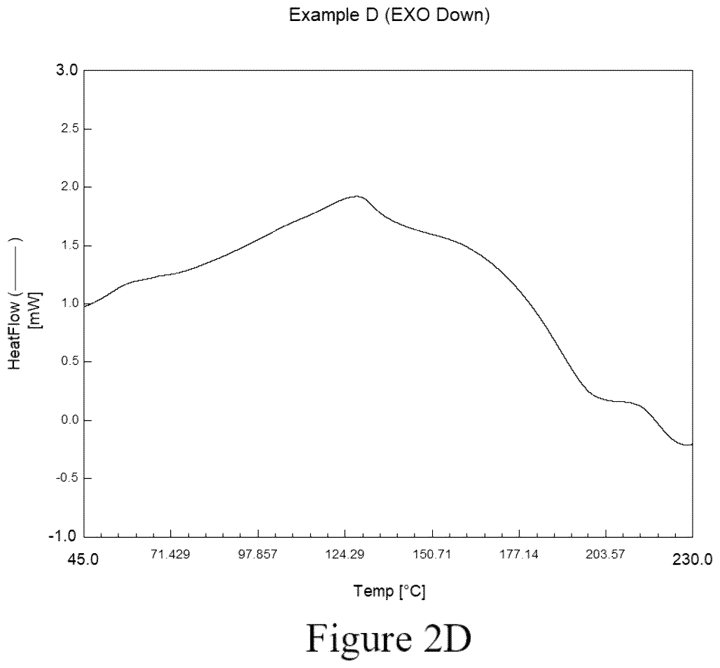

DSC was run on each specimen according to ASTM E794-06 (ramp rate of 5° C./min, 50 mL/min N2 purge, at range of 25-300° C.). Peaks and transitions, if any, were determined and results are shown in Table 1. The DSC measurements are based on two specimen samples. One of the two specimen DSC curve for each samples A-D are shown FIG. 2.

TABLE 1
Samples

| Sample | A | B | C | D |
|---|---|---|---|---|
| 2-Propylheptyl acrylate | 6.00 | 7.35 | 6.00 | — |
| N-acryloylmorpholine | 40.6 | 49.8 | 40.6 | 46.6 |
| Thermally reversible | 17.1 A | 20.9 A | — | 17.1 A |
| crosslinker* | 16.5 B | 20.2 B | | 16.5 B |
| Urethane dimethacrylate | — | — | 33.6 | — |
| oligomer | | | | |
| crosslinker (not reversible) | | | | |
| Omirad TOP | 1.00 | 1.00 | 1.00 | 1.00 |
| Omirad 184 | 0.75 | 0.75 | 0.75 | 0.75 |
| Ethyl 2-tosyloxyacrylate | 18.1 | — | 18.1 | 18.1 |
| DSC | FIG. | FIG. | FIG. | FIG. |
| | 2A | 2B | 2C | 2D |
| endothermic peak (° C.) | 110 | 130 | None | 130 |
| Endothermic transition (° C.) | 70-160 | None | None | None |

*A wt % 4,4′-bismaleimidodiphenylmethane + B wt % furfuryl methacrylate

Examples A contains the thermally reversible cross-linker, additive for controlling MW, high Tg component, and low Tg component. As shown in FIG. 2A, there are endothermic peaks at 110° C. and 130° C., which correspond to retro Diels-Alder reactions (thermal de-crosslinking). Additional endothermic transitions at 70° C. and 100° C. are shown in Example A, which is indicative of melting. Example A melted into liquid above 130° C. Example B does not contain the additive for controlling MW, thus only softened above 130° C., without any signs of melting.

For Example C, the thermally reversible crosslinker was replaced with a standard crosslinker, urethane methacrylate oligomer. As shown in its DSC curve, no endothermic transition occurred, this sample remained as a thermoset and did not melt or soften at above 150° C.

Example D is devoid of any low Tg component. The respective DSC curve showed an endothermic peak exhibited at 130° C. that corresponded to retro Diels-Alder reaction, but the composition did not melt above 150° C. Gel-like material formed at above 130° C.

I/We claim:

1. An investment casting pattern composition comprising:
A) a monomer A having a glass transition temperature value less than about 25° C.;
B) a monomer B having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, irreversible chain transfer agent, antioxidant, hindered amine light stabilizer, or mixtures thereof.

2. The investment casting pattern composition of claim 1, wherein the monomer A has a functional group selected from methacrylate, acrylate, vinyl ester, vinyl ether, allyl, N-vinyl, vinylamide, acrylamide, vinyl carbonate, acryloyl, vinyl arbamate, maleimide, cyanoacrylate, thiol or epoxy.

3. The investment casting pattern composition of claim 2, wherein the monomer A has a functional group selected from methacrylate, acrylate, N-vinyl, acrylamide, maleimide or acryloyl.

4. The investment casting pattern composition of claim 1, wherein the monomer B has a functional group is selected from methacrylate, acrylate, vinyl ester, vinyl ether, allyl, N-vinyl, vinylamide, acrylamide, vinyl carbonate, acryloyl, vinyl arbamate, maleimide, cyanoacrylate, thiol or epoxy.

5. The investment casting pattern composition of claim 4, wherein the monomer B has a functional group is selected from narrow methacrylate, acrylate, N-vinyl, acrylamide, maleimide or acryloyl.

6. The investment casting pattern composition of claim 1, wherein the thermally reversible crosslinker is prepared by reacting
a) bismaleimide or a compound having to two or more maleimide group with
b) furfuryl methacrylate or furfuryl arylate
wherein the molar ratio of a to b is 0.5-2 equivalents.

7. The investment casting pattern composition of claim 1, wherein the photoinitiator is a Norish type I initiators selected from 2,4,6-trimethylbenzoyl-diphenyl phosphine oxide (TPO), 1-Hydroxycyclohexyl-phenyl ketone, bis(2,4,6-trimethylbenzoyl)-phenylphosphineoxide (BAPO) or ethyl (2,4,6-trimethylbenzoyl)phenylphosphinate (TPO-L).

8. The investment casting pattern composition of claim 1, wherein the additive is a chain transfer agent selected from the group consisting of allyl sulfide, allyl phenyl sulfone, ethyl 2-tosyloxyacrylate, ethyl 2-(1-hydroxyperoxyethyl) propenoate, mono-beta-allyl sulfone, alpha-(benzyloxy) styrene, carbon tetrachloride, carbon tetrabromide, bromotrichloromethane, 4-methylbenzenethiol, pentaphenylethane, tert-nonyl mercaptan, 4,4′-thiobisbenzenethiol, n-octyl mercaptan, thioglycolic acid, and mixtures thereof.

9. The investment casting pattern composition of claim 1, which has a melting temperature of about 100 to about 250° C.

10. A photocurable composition comprising:
A) a monomer A having a glass transition temperature value less than about 25° C.;
B) a monomer B having a glass transition temperature value greater than about 25° C.;
C) an oligomer having two or more furan maleimide Diels-Alder adduct;
D) a photoinitiator; and
E) an additive selected from the group consisting of a chain transfer agent, irreversible chain transfer agent, addition fragmentation chain transfer agent (AFCT), antioxidant, hindered amine light stabilizer, or mixtures thereof.

11. The photocurable composition of claim 10, wherein the monomer A has a functional group consisting of methacrylate, acrylate, vinyl ester, vinyl ether, allyl, N-vinyl, and mixtures thereof.

12. The photocurable composition of claim 10, wherein the monomer B has a functional group consisting of methacrylate, acrylate, vinyl ester, vinyl ether, allyl, N-vinyl, and mixtures thereof.

13. The photocurable composition of claim 10, wherein oligomer is prepared by reacting
a) bismaleimide or a compound having to two or more maleimide group with
b) furfuryl methacrylate or furfuryl arylate
wherein the molar ratio of a to b is 0.5-2 equivalents.

14. The photocurable composition of claim 10, wherein the photoinitiator is a Norish type I initiators selected from 2,4,6-trimethylbenzoyl-diphenyl phosphine oxide (TPO), 1-Hydroxycyclohexyl-phenyl ketone, bis(2,4,6-trimethylbenzoyl)-phenylphosphineoxide (BAPO) or ethyl (2,4,6-trimethylbenzoyl)phenylphosphinate (TPO-L).

15. The photocurable composition of claim 10, wherein the additive is a chain transfer agent selected from the group consisting of allyl sulfide, allyl phenyl sulfone, ethyl 2-tosyloxyacrylate, ethyl 2-(1-hydroxyperoxyethyl) propenoate, mono-beta-allyl sulfone, alpha-(benzyloxy) styrene, carbon tetrachloride, carbon tetrabromide, bromotrichloromethane, 4-methylbenzenethiol, pentaphenylethane, tert-nonyl mercaptan, 4,4′-thiobisbenzenethiol, n-octyl mercaptan, thioglycolic acid, and mixtures thereof.

16. The photocurable composition of claim 10, which has a melting temperature of about 100 to about 250° C.

17. A cured photocurable composition of claim 10.

18. A method of making a three-dimensional investment shell comprising the steps of:
1) forming a three-dimensional pattern by
a. preparing a photocurable composition comprising:
A) a monomer A having a glass transition temperature value less than about 25° C.;
B) a monomer B having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, irreversible chain transfer agent, antioxidant, hindered amine light stabilizer, or mixtures thereof; and
b. photocuring the photocurable composition to form a hardened three-dimensional pattern having a first side and a second side, and wherein the second side is the outermost side;
2) applying a slurry solution onto the second side of the hardened three-dimensional pattern;
3) drying, curing or hardening the slurry solution to form a shell on the hardened pattern;
4) heating the hardened three-dimensional pattern and the shell to a temperature sufficient to soften the hardened three-dimensional pattern; and
5) separating the hardened three-dimensional pattern from the shell.

19. The method of making the shell of claim 18, wherein the temperature in step 4) is from about 130 to about 250° C.

20. A method of making an object comprising the steps of:
1) preparing a pattern having a first side and a second side, wherein the second side is on the outermost side, wherein the pattern is prepared by photocuring a photocurable composition comprising:
A) a monomer A having a glass transition temperature value less than about 25° C.;
B) a monomer B having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, irreversible chain transfer agent, antioxidant, hindered amine light stabilizer, or mixtures thereof; and
2) applying a slurry solution onto the second side of the pattern;
3) drying, curing or hardening the slurry solution to form a shell on the second side of the pattern;
4) heating the pattern and shell to a temperature sufficient to soften the pattern;
5) separating the pattern from the shell having a first side and a second side, wherein the first side is the innermost side;
6) applying a second composition on the first side of the shell
7) curing, drying or hardening the second composition; and
8) removing the shell from the second composition
whereby forming the object.

21. A method of making a thermally reversible, photocurable composition comprising the steps of:
1) combining and mixing the following components to form a mixture:
A) a monomer A having a glass transition temperature value less than about 25° C.;
B) a monomer B having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, irreversible chain transfer agent, antioxidant, hindered amine light stabilizer, or mixtures thereof;
2) applying the mixture onto a substrate or depositing the mixture as a self-supporting 3D structure; and
3) photocuring the mixture to harden the removable photocurable composition.

22. The method of making the thermally reversible, photocurable composition of claim 21, wherein the applying the mixture is digital light processing, stereolithography, slot die coating, spray coating, wet-coating, screen-printing UV-nano-imprint lithography or photo-nano imprint lithography, step and flash imprint lithography, selective laser sintering, fused deposition modeling, fused filament fabrication, polyjet, or inkjet printing
